(19) United States
(12) Patent Application Publication
(10) Pub. No.: US 2026/0051698 A1
(43) Pub. Date: Feb. 19, 2026

(54) PLUG CONNECTOR WITH ROTATABLE LATCH

(71) Applicant: TE Connectivity Solutions GmbH, Schaffhausen (CH)

(72) Inventors: Keith Edwin MILLER, Manheim, PA (US); Kyle Gary ANNIS, Hummeistown, PA (US)

(73) Assignee: TE Connectivity Solutions GmbH, Schaffhausen (CH)

(21) Appl. No.: 18/806,871

(22) Filed: Aug. 16, 2024

(51) Int. Cl. H01R 13/627; H01R 13/6581

(52) U.S. Cl. CPC H01R 13/6275; H01R 13/6581; H01R 2201/26

(57) ABSTRACT

A connector assembly with a first connector and a second connector. The first connector has an inner component and an outer component. The outer component is rotatably mounted to the inner component. The second connector is mounted to the outer component of the first connector. The rotatably mounted outer component rotates independently of the inner component, The independent rotation of the outer component allows a user to rotate the second component relative to the first component to make a connection between the first connector and a mating first connector and a connection between the second connector and a mating second connector, without the need to rotate or twist the inner housing.

### BACKGROUND OF THE INVENTION

The invention relates generally to a connector assembly with an electrical plug connector with a rotatable latch which allows the insertion of the plug connector into a receptacle connector without the need to twist the plug wire. In particular, the invention relates to a high voltage connector assembly that incorporates a high voltage interlock loop connector assembly.

Connectors may be used in high voltage applications, such as in hybrid or all-electric automobiles or aircrafts, to transfer relatively high voltage current from a power source to one or more electric loads. For example, connectors may electrically couple a battery with motors, heating elements, control systems, transmissions, and the like, in an automobile or aircraft. The high voltage current that is transmitted using these connectors may require safeguards to ensure that operators of the automobile and other electronic components in the automobile are not harmed by the current.

Due to the high voltage and large amperage involved, it is a prerequisite to shut down the high voltage circuit in question before a technician or other individual disconnects any high voltage connector. To prevent premature physical contact with the high voltage circuit, interlock loop circuitry, often referred to as high voltage interlock loops (HVIL), have been devised which when triggered will activate a shut-off program to shut down the high voltage circuit. One such trigger is an interlock loop connector in the HVIL circuit that often is piggybacked onto the high voltage connectors to allow the high voltage electrical circuit to shut down and adequately discharge after the HVIL circuit becomes disconnected but before the connector housing of the high voltage connector assembly can become disconnected.

But, header connectors are fixed in location. For example, header connectors may only be mounted to the exterior of a device. A need exists for a connector that is not mounted as a header connector and that closes an interlock circuit. Another problem is having numerous connectors to mate with each different HV connector having a high voltage interlock (HVIL) circuit.

Present HVIL connectors system are costly, bulky and contain extra parts. In particular, known high voltage connectors have a HVIL shunt, but do not have the capability to connect HVIL wires to the plug side of the connector assembly. In addition, due to the orientation of the connector assembly during mating, the plug side of the connector assembly requires a unique stamped and formed shield with two interfaces to achieve rotatability.

It would, therefore, be beneficial to provide a high voltage, sealed and shielded power connector assembly with a high voltage interlock (HVIL) circuit that enables shielding and grounding to be maintained from the wire through the connector to the panel into which it is mounted. In particular, it would be beneficial to provide the male or plug connector of the power connector assembly with an outer component which rotates around the inner components to properly align the plug connector to the header connector without needing to twist the plug wire.

### SUMMARY OF THE INVENTION

An embodiment is directed to a connector assembly with a first connector and a second connector. The first connector has an inner component and an outer component. The outer component is rotatably mounted to the inner component. The second connector is mounted to the outer component of the first connector. The rotatably mounted outer component rotates independently of the inner component, The independent rotation of the outer component allows a user to rotate the second component relative to the first component to make a connection between the first connector and a mating first connector and a connection between the second connector and a mating second connector, without the need to rotate or twist the inner housing.

An embodiment is directed to a connector assembly. The connector assembly includes a high voltage assembly with an inner component and an outer component, the outer component is rotatably mounted to the inner component. A HVIL connector is mounted to the outer component of the high voltage connector assembly. The rotatably mounted outer component rotates independently of the inner component. The independent rotation of the outer component allows a user to rotate the outer component to make a connection between the high voltage assembly and a mating high voltage assembly and a connection between the HVIL connector and a mating HVIL connector, without the need to rotate or twist the inner housing.

An embodiment is directed to a high voltage and HVIL connector assembly having a first high voltage assembly and a second high voltage assembly. The first high voltage assembly has an inner component and an outer component, the outer component being rotatably mounted to the inner component. A first HVIL connector is mounted to the outer component of the first high voltage connector assembly. A second HVIL connector is mounted to the second high voltage assembly. The rotatably mounted outer component rotates independently of the inner component. The independent rotation of the outer component allows a user to rotate the outer component to make a connection between the first high voltage assembly and the second high voltage assembly and a connection between the first HVIL connector and the second HVIL connector, without the need to rotate or twist the inner housing.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a back perspective view of an illustrative power connector assembly of the present invention, showing a male or plug connector prior to insertion into a header connector.

FIG. 2 is a front perspective view of the illustrative power connector assembly of FIG. 1, showing the male or plug connector prior to insertion into the header connector.

FIG. 3 is a front perspective view of the illustrative power connector assembly of FIG. 2, showing the male or plug connector prior inserted into the header connector.

FIG. 4 is a cross-sectional view of the assembled power connector assembly, taken along line 4-4 of FIG. 3.

FIG. 5 is a cross-sectional view of the assembled power connector assembly, taken along line 5-5 of FIG. 3.

FIG. 6 is a cross-sectional view of the male or plug connector with the wires removed.

FIG. 7 is a perspective view of the male or plug connector with an outer component removed.

FIG. 8 is a perspective view of the outer component of the male or plug connector.

FIG. 9 is a cross-sectional view of an alternate illustrative embodiment of the male or plug connector with the wires removed.

FIG. 10 is a perspective view of a centering member of the male or plug connector of FIG. 9.

FIG. 11 is a perspective view of the outer component of the male or plug connector of FIG. 9.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

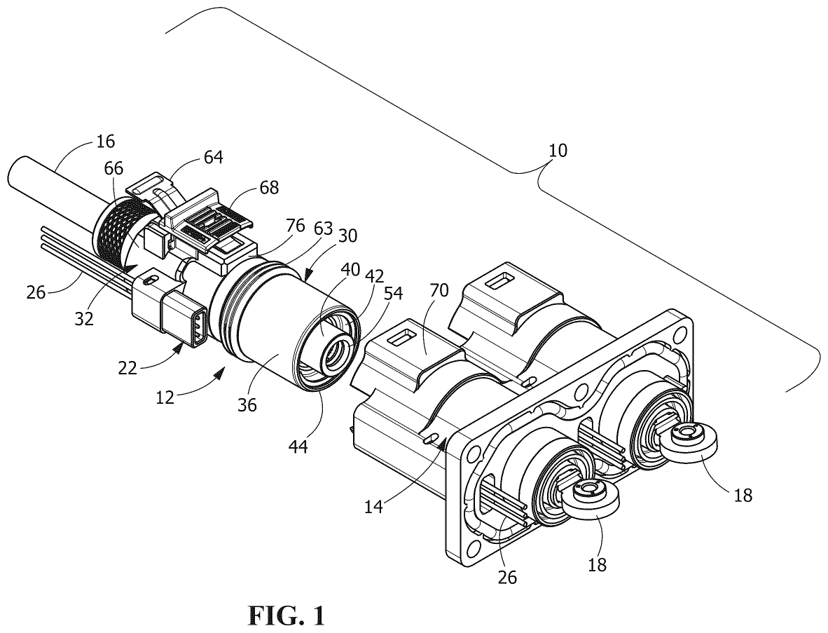

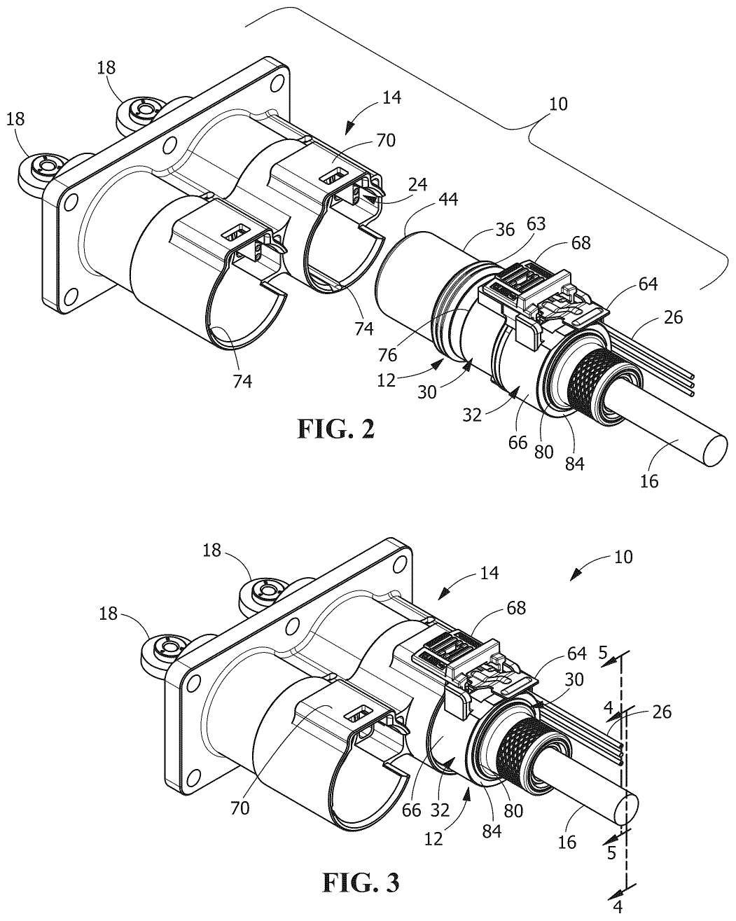

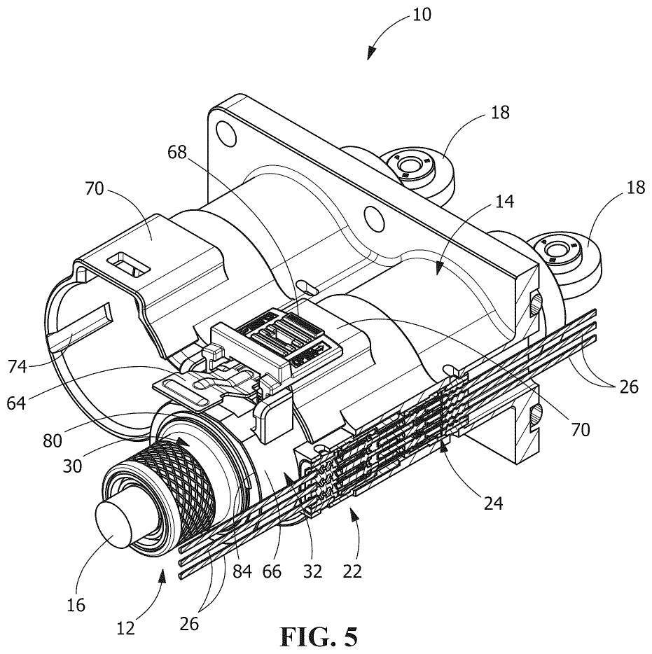

As shown in FIGS. 1 through 5, a high voltage and HVIL connector assembly 10 is shown with a first or male high voltage assembly 12 and a second or female high voltage assembly 14. A high voltage wire 16 extends from the male high voltage 12 and a high voltage terminal 18 extends from the female high voltage 14. When the male high voltage assembly 12 is properly inserted into the female high voltage assembly 14, as shown in FIGS. 3 through 5, the high voltage wires 16 makes an electrical connection with the high voltage terminal 18 to form a part of a high voltage circuit.

A first or male HVIL connector 22 is rotatably positioned on the male high voltage assembly 12. A second or female HVIL connector 24 is mounted on the female high voltage assembly 14. The connector 24 may be integrally formed with or assembled into the female high voltage assembly 14. Low voltage HVIL wires 26 are operably connected to the HVIL connectors 22 and 24 that contact each other to form part of an HVIL circuit.

When mating the first or male high voltage assembly 12 to the second or female high voltage assembly 14, the first or male HVIL connector 22 makes an electrical connection to the second or female HVIL connector 24 prior to the first or male high voltage assembly 12 making an electrical connection to the second or female high voltage assembly 14, thereby closing the HVIL circuit. Until the HVIL circuit is closed, the high voltage circuit of the first or male high voltage assembly 12 and the second or female high voltage assembly 14 is not energized. This prevents accidental exposure to the high voltage circuit and prevents arcing between the high voltage contacts of the first or male high voltage assembly 12 and the second or female high voltage assembly 14 during mating.

During unmating or during operation, when the first or male HVIL connector 22 becomes disconnected from the second or female HVIL connector 24, the HVIL circuit becomes open. When the HVIL circuit is open, the high voltage circuit is opened by disconnecting from a high voltage source (not shown). This prevents accidental exposure to the high voltage circuit and prevents arcing between the high voltage contacts of the first or male high voltage assembly 12 and the second or female high voltage assembly 14 during unmating.

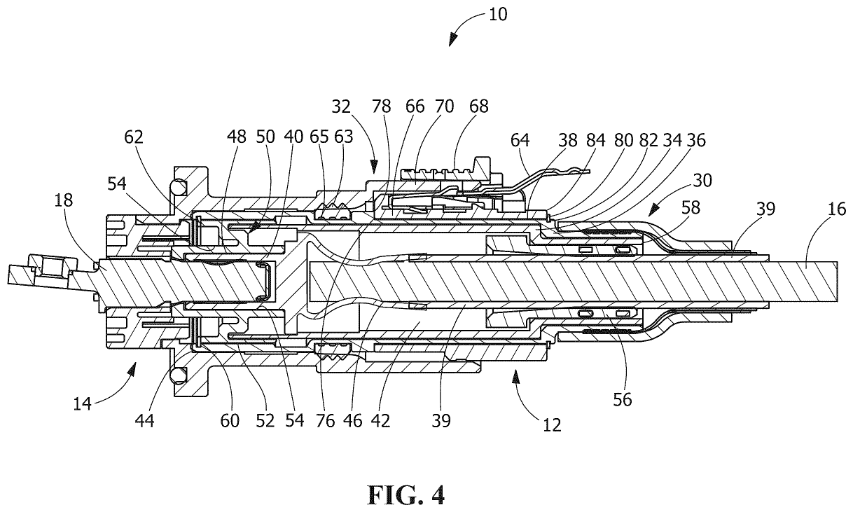

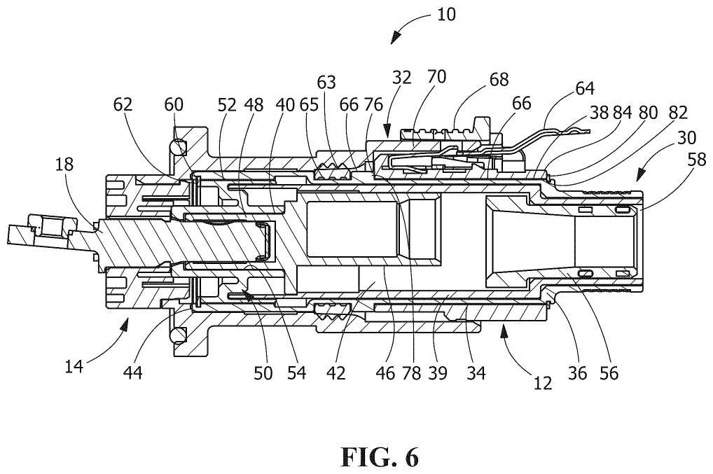

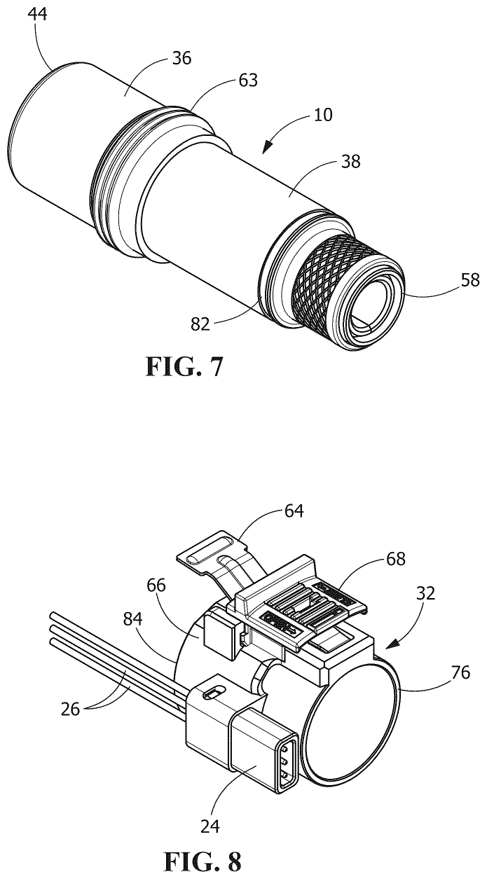

Referring to FIGS. 4 through 8, the male high voltage assembly 12 has an inner component 30 and an outer component 32 which is rotatably mounted to the inner component 30. In the illustrative embodiment shown, the inner component 30 includes a housing 34 with a grounding/shielding member 36 which is positioned about the outer circumference of the housing 34. The grounding/shielding member 36 has an outer component receiving recess 38 which extends about an outer circumference of the grounding/shielding member 36. The housing 34 also includes an inner insulation member 39 which is positioned in a conductor receiving passage 42.

A socket contact 40 is positioned in the conductor receiving passage 42 in the housing 34 proximate a mating end 44 of the housing 34. The socket contact 40 has a conductor receiving end 46 and a mating contact receiving end 48. In the illustrative embodiment shown, the mating contact receiving end 46 has a louver contact section 49, however, other types of contact sections may be used.

A centering member 50 is positioned in the conductor receiving passage 42 proximate the mating end 44 of the housing 34. The centering member 50 has an outer wall 52 which cooperates with an inner wall of the conductor receiving passage 42. A socket contact receiving passage 54 extends through the centering member 50 and is positioned along a longitudinal axis of the centering member 50. When assembled, the outer wall 52 of the centering member 50 engages the inner wall of the conductor receiving passage 42 and the socket contact receiving passage 54 engages the conductor receiving end 46 of the socket contact 40 to properly center the socket contact 40 in the housing 42.

A wire support component 56 is provided in the conductor receiving passage 42 proximate a conductor receiving end 58 of the housing 34. The wire support component 56 cooperates with the high voltage wire 16 to properly position and retain the high voltage wire 16 in position in the conductor receiving passage 42 of the housing 42. In the illustrative embodiment, the wire support component 56 made of two pieces to allow the wire support component 56 to be easily positioned on the high voltage wire 16. However, other configurations of the wire support component 56 may be used, such as, but not limited to, a heat shrinkable component.

A retaining ring 60 is provided proximate the mating end 44 of the housing. The retaining ring 60 is positioned in a retaining ring receiving recess 62 which extends about an inner circumference of the grounding/shielding member 36. The retaining ring 60 cooperates with the centering member 50 to maintain the centering member 50 in position in the conductor receiving passage 42 of the housing 34.

An environmental seal 63 is provided in a seal recess 65 which extends about the outer circumference of the grounding/shielding member 36. The environmental seal 63 is configured to cooperate with the female high voltage assembly 14 to prevent the ingress of moisture and other contaminates when the male high voltage assembly 12 is mated with the female high voltage assembly 14.

As shown in FIG. 8, the outer component 32 is a cylindrical member which is positioned in the outer component receiving recess 38 of the grounding/shielding member 36. The outer component 32 has a latch 64 which extends from an outer surface 66 of the outer component 32 in a direction away from the inner component 30. The latch 64 has a connector position assurance member 68.

The male HVIL connector 22 is provided on outer component 32 and is spaced from the latch 64. The male HVIL connector 22 extends from the outer surface 66 of the outer component 32 in a direction away from the inner component 30. The particular configuration and spacing of the latch 64 and the male HVIL connector 22 is dependent upon the configuration and spacing of the latch 70 and the female HVIL connector of the female high voltage assembly 14.

In the illustrative embodiment, an alignment keying projection 72 is provided on outer component 32 and is spaced from the latch 64 and the male HVIL connector 22. The alignment keying projection 72 extends from the outer surface 66 of the outer component 32 in a direction away from the inner component 30. The particular configuration and spacing of the alignment keying projection 72 is dependent upon the configuration and spacing of an alignment keying recess 74 which is provided on the female high voltage assembly 14.

The outer component 32 is inserted into the outer component receiving recess 38 from the conductor receiving end 58 of the housing 34. The outer component 32 is moved toward the mating end 44 of the housing 34 until a leading edge 76 of the outer component 32 engages a shoulder 78 of the outer component receiving recess 38, there preventing further movement of the outer component 32 toward the mating end 44. With the outer component 32 properly positioned, an outer component retaining ring 80 is positioned in an outer component retaining ring receiving recess 82, as shown in 4, 6 and 7. In this position, the outer component retaining ring 80 cooperates with a trailing edge 84 of the outer component 32 to prevent the movement of the outer component 32 back toward the conductor receiving end 58 of the housing 34. With the outer component retaining ring 80 properly positioned, the outer component 32 is secured to the inner component 30 in such a manner that the outer component 32 can rotate about the inner component 30.

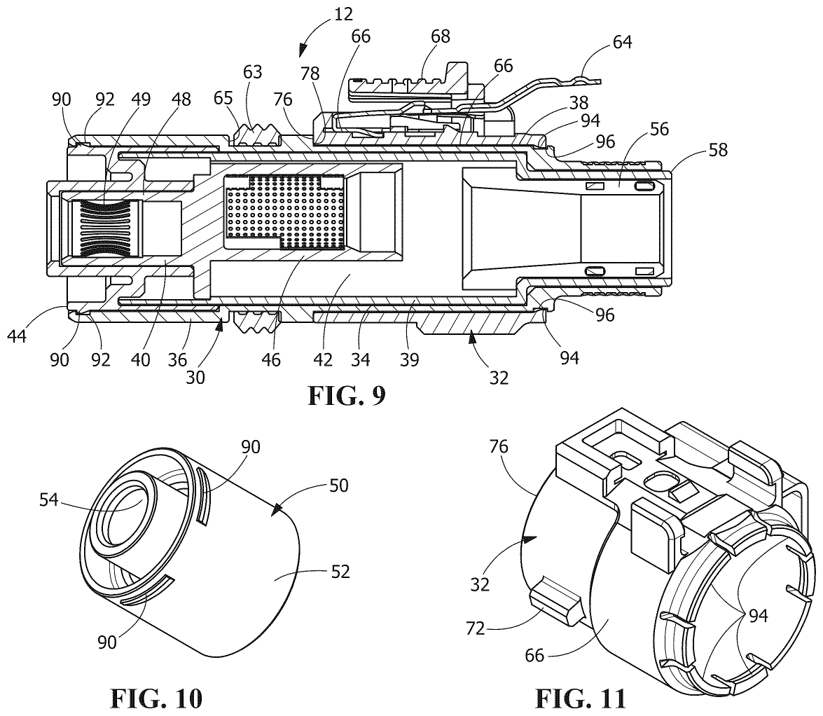

An alternate exemplary embodiment is shown in FIGS. 9 through 11. In this embodiment, the centering member 50 has one or more locking projections 90 which cooperate one or more locking projection receiving recesses 92 to maintain the centering member 50 in position in the conductor receiving passage 42 of the housing 34. This eliminates the need for the retaining ring 60 and the retaining ring receiving recess 62 of the previous embodiment.

In the embodiment shown in FIGS. 9 through 11, the outer component 32 has one or more locking projections 94 which cooperate with a locking projection receiving recess 96. As the outer component 32 is inserted into the outer component receiving recess 38 from the conductor receiving end 58 of the housing 34, the outer component 32 is moved toward the mating end 44 of the housing 34 until a leading edge 76 of the outer component 32 engages a shoulder 78 of the outer component receiving recess 38, there preventing further movement of the outer component 32 toward the mating end 44. As this occurs, the one or more locking projections 94 are moved into the locking projection receiving recess 96, thereby preventing the movement of the outer component 32 back toward the conductor receiving end 58 of the housing 34. With the one or more locking projections 94 properly positioned in the locking projection receiving recess 96, the outer component 32 is secured to the inner component 30 in such a manner that the outer component 32 can rotate about the inner component 30.

The other features of the alternate illustrative embodiment shown in FIGS. 9 through 11 are the same as those described for the illustrative embodiment shown in FIG. 1 through 8.

The use of a rotatably mounted outer component 32 allows the outer component 32 to rotate independently of the inner component 30 and the high voltage wire 16. As the high voltage wire 16 can be of a large size, the independent rotation of the outer component 32 allows the user to rotate the outer component 32 to make the connection between the male high voltage assembly 12 and a female high voltage assembly 14, including the connection between the male HVIL connector 22 and the female HVIL connector 24, without the need to rotate or twist the inner housing 30 and the wire high voltage wire 16 to a specific orientation.

The high voltage and HVIL connector assembly 10 prevents unwanted and undesirable premature connection of the low voltage HVIL circuit while also preventing unwanted and undesirable premature disconnection of a high voltage circuit of an electrically driven motor vehicle before the low voltage circuit is disconnected.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A connector assembly comprising:
a first connector having an inner component and an outer component, the outer component being rotatably mounted to the inner component;
a second connector mounted to the outer component of the first connector;
the rotatably mounted outer component rotates independently of the inner component;
wherein the independent rotation of the outer component allows a user to rotate the second component relative to the first component to make a connection between the first connector and a mating first connector and a connection between the second connector and a mating second connector, without the need to rotate or twist the inner housing.

2. The connector assembly as recited in claim 1, wherein the inner component has an outer component receiving recess which extends about an outer circumference of the inner component.

3. The connector assembly as recited in claim 2, wherein a contact is positioned in a conductor receiving passage of the housing proximate a mating end of the housing.

4. The connector assembly as recited in claim 2, wherein a centering member is positioned in the conductor receiving passage proximate the mating end of the housing, the centering member has an outer wall which cooperates with an inner wall of the conductor receiving passage, a contact receiving passage extends through the centering member and is positioned along a longitudinal axis of the centering member, the outer wall of the centering member engages the inner wall of the conductor receiving passage and the contact receiving passage engages a conductor receiving end of the contact to properly center the contact in the housing.

5. The connector assembly as recited in claim 2, wherein the outer component is a cylindrical member which is positioned in the outer component receiving recess of the inner component, the outer component has a latch which extends from an outer surface of the outer component in a direction away from the inner component.

6. The connector assembly as recited in claim 5, wherein the second connector is provided on outer component and is spaced from the latch, the second connector extends from the outer surface of the outer component in a direction away from the inner component.

7. The connector assembly as recited in claim 6, wherein an alignment keying projection is provided on outer component and is spaced from the latch and the second connector, the alignment keying projection extends from the outer surface of the outer component in a direction away from the inner component.

8. The connector assembly as recited in claim 2, wherein the outer component is retained in the outer component receiving recess by an outer component retaining ring positioned in an outer component retaining ring receiving recess of the inner component.

9. The connector assembly as recited in claim 2, wherein the outer component has one or more locking projections which cooperate with a locking projection receiving recess of the inner component to retain the outer component in position.

10. A connector assembly comprising:
a high voltage assembly having an inner component and an outer component, the outer component being rotatably mounted to the inner component;
a HVIL connector mounted to the outer component of the high voltage connector assembly;
the rotatably mounted outer component rotates independently of the inner component;
wherein the independent rotation of the outer component allows a user to rotate the outer component to make a connection between the high voltage assembly and a mating high voltage assembly and a connection between the HVIL connector and a mating HVIL connector, without the need to rotate or twist the inner housing.

11. The connector assembly as recited in claim 10, wherein the inner component has a housing with a grounding/shielding member which is positioned about the outer circumference of the housing, the grounding/shielding member has an outer component receiving recess which extends about an outer circumference of the grounding/shielding member.

12. The connector assembly as recited in claim 11, wherein the outer component is retained in the outer component receiving recess by an outer component retaining ring positioned in an outer component retaining ring receiving recess of the grounding/shielding member.

13. The connector assembly as recited in claim 11, wherein the outer component has one or more locking projections which cooperate with a locking projection receiving recess of the grounding/shielding member to retain the outer component in position.

14. The connector assembly as recited in claim 11, wherein a centering member is positioned in a conductor receiving passage of the inner component proximate the mating end of the housing, the centering member has an outer wall which cooperates with an inner wall of the conductor receiving passage, a socket contact receiving passage extends through the centering member and is positioned along a longitudinal axis of the centering member, the outer wall of the centering member engages the inner wall of the conductor receiving passage and the socket contact receiving passage engages a conductor receiving end of a socket contact to properly center the socket contact in the housing.

15. The connector assembly as recited in claim 11, wherein the outer component is a cylindrical member which is positioned in the outer component receiving recess of the grounding/shielding member, the outer component has a latch which extends from an outer surface of the outer component in a direction away from the inner component.

16. The connector assembly as recited in claim 15, wherein the HVIL connector is provided on outer component and is spaced from the latch, the HVIL connector extends from the outer surface of the outer component in a direction away from the inner component.

17. The connector assembly as recited in claim 16, wherein an alignment keying projection is provided on outer component and is spaced from the latch and the HVIL connector, the alignment keying projection extends from the outer surface of the outer component in a direction away from the inner component.

18. A high voltage and HVIL connector assembly comprising:
a first high voltage assembly having an inner component and an outer component, the outer component being rotatably mounted to the inner component;
a second high voltage assembly;
a first HVIL connector mounted to the outer component of the first high voltage connector assembly;
a second HVIL connector mounted to the second high voltage assembly;
the rotatably mounted outer component rotates independently of the inner component;
wherein the independent rotation of the outer component allows a user to rotate the outer component to make a connection between the first high voltage assembly and the second high voltage assembly and a connection between the first HVIL connector and the second HVIL connector, without the need to rotate or twist the inner housing.

19. The high voltage and HVIL connector assembly as recited in claim 18, wherein the inner component has a housing with a grounding/shielding member which is positioned about the outer circumference of the housing, the grounding/shielding member has an outer component receiving recess which extends about an outer circumference of the grounding/shielding member.

20. The high voltage and HVIL connector assembly as recited in claim 19, wherein a centering member is positioned in a conductor receiving passage of the inner component proximate the mating end of the inner component, the centering member has an outer wall which cooperates with an inner wall of the conductor receiving passage, a socket contact receiving passage extends through the centering member and is positioned along a longitudinal axis of the centering member, the outer wall of the centering member engages the inner wall of the conductor receiving passage and the socket contact receiving passage engages a conductor receiving end of a socket contact to properly center the socket contact in the housing.
